(19) United States
(12) Patent Application Publication
(10) Pub. No.: US 2015/0329744 A1
(43) Pub. Date: Nov. 19, 2015

(54) FILM FOR TIRE INNER LINER AND METHOD FOR MANUFACTURING THE SAME

(71) Applicant: KOLON INDUSTRIES, INC., Gwacheon-si, Gyeonggi-do (KR)

(72) Inventors: Young-Han JEONG, Yongin-si (KR); So-Yeon KWON, Yongin-si (KR); Hyun NAMGOONG, Yongin-si (KR); Seong-Hun KIM, Yongin-si (KR)

(73) Assignee: KOLON INDUSTRIES, INC., Gwacheon-si, Gyeonggi-do (KR)

(21) Appl. No.: 14/654,337

(22) PCT Filed: Dec. 16, 2013
(86) PCT No.: PCT/KR2013/011626

§ 371 Date: Jun. 19, 2015

(30) Foreign Application Priority Data
Dec. 31, 2012 (KR) 10-2012-0158573
Dec. 12, 2013 (KR) 10-2013-0154636

(51) Int. Cl. C09J 7/02; B29D 30/06

(52) U.S. Cl. CPC C09J 7/0282; B29D 30/0681; C09J 2461/00; C09J 2477/006; C09J 2201/122; B29D 2030/0682

(57) ABSTRACT

This disclosure relates to a film for an inner liner including a base film layer and an adhesive layer, the base film layer including a polyamide-based resin, a specific copolymer, and a polymer crystallization retardant, and a method for manufacturing the same.

### TECHNICAL FIELD

The present invention relates to a film for a tire inner liner and a method for manufacturing the same. More specifically, the present invention relates to a film for a tire inner liner capable of implementing an excellent gas barrier property even with a thin thickness to lighten a tire weight, improve mileage of automobiles, and have mechanical physical properties such as durability, fatigue resistance, and the like, together with excellent formability, and a method for manufacturing the film for a tire inner liner.

### BACKGROUND OF THE INVENTION

A tire withstands a weight of an automobile, reduces impact from the road, and transfers driving force or braking force of an automobile to the ground. In general, the tire is a complex of fiber/steel/rubber, and has a structure as shown in FIG. 1.

Tread (1): a part contacting the road. It should afford frictional force required for driving, have good wear resistance, withstand external impact, and have low heat generation.

Body ply, or carcass (6): a cord layer in the tire. It should support the vehicle weight, withstand impact, and have high fatigue resistance to bending and stretching while driving.

Belt (5): located between the body plies, consists of steel wire in most cases, reduces external impact, and maintains a wide tread to afford excellent vehicle driving stability.

Side wall (3): a rubber layer between a part below a shoulder (2) and a bead (9). It protects the inner body ply (6).

Inner liner (7): located inside the tire instead of a tube, and prevents air leakage to enable a pneumatic tire.

Bead (9): square or hexagonal wire bundle formed of rubber-coated steel wire. It positions and fixes the tire to a rim.

Cap ply (4): a special cord located on a belt of a radial tire for some cars. It minimizes movement of the belt during driving.

Apex (8): triangular rubber filler used to minimize dispersion of the bead, reduce external impact to protect the bead, and prevent air inflow during forming.

A tubeless tire where high pressure air of about 30 to 40 psi is injected without using a tube is commonly used, and to prevent air leakage during automobile driving, an inner liner having a high gas barrier property is positioned as the inner layer of the carcass.

Previously, a tire inner liner including rubber such as butyl rubber, halobutyl rubber, and the like having relatively low air permeability as a main ingredient was used, but to achieve a sufficient gas barrier property of the inner liner, the rubber content or inner liner thickness should be increased. However, if the rubber content and tire thickness are increased, total weight of the tire may be increased and mileage of automobiles may be degraded.

Further, since the rubber ingredients have relatively low heat resistance, air pockets may be generated between rubber in the inner surface of a carcass layer and the inner liner, or the shape or properties of the inner liner may be changed in a vulcanization process of a tire or in an automobile driving process during which repeated deformations occur at a high temperature. To bond the rubber ingredients to a carcass layer of a tire, a vulcanizer should be used or a vulcanization process should be applied, but sufficient adhesion may not be secured therewith.

Therefore, various methods have been suggested to decrease the thickness and weight of the inner liner to increase mileage and reduce changes in the shape or properties of the inner liner during vulcanization of a tire or driving, and the like.

However, previously known methods have limitations in maintaining excellent air permeability and formability of a tire while sufficiently decreasing the thickness and weight of the inner liner. In addition, the inner liner manufactured by the previously known method exhibited physical property degradation or generated cracks and the like in a tire manufacturing process during which repeated deformations occur at a high temperature, or in an automobile driving process during which repeated deformations occur and high heat is generated.

### DETAILED DESCRIPTION OF THE INVENTION

### Technical Objectives

It is an object of the invention to provide a film for an inner liner capable of implementing an excellent gas barrier property even with a thin thickness to lighten a tire weight, improve mileage of automobiles, and have mechanical physical properties such as high durability, fatigue resistance, and the like, together with excellent formability.

In addition, it is another object of the invention to provide a method for manufacturing the film for an inner liner.

### Technical Solutions

There is provided a film for an inner liner including: a base film layer including a polyamide-based resin (a), a copolymer (b) including polyamide-based segments and polyether-based segments, and a polymer crystallization retardant (c); and an adhesive layer formed on at least one surface of the base film layer and including a resorcinol-formalin-latex (RFL)-based adhesive, wherein a content of the polyether-based segment of the copolymer is 2 wt % to 40 wt % based on total weight of the base film layer.

In addition, there also is provided a method for manufacturing a film for an inner liner including: forming a base film layer by melting and extruding a mixture at 230 to 300 t, the mixture including a polyamide-based resin (a), a copolymer (b) including polyamide-based segments and polyether-based segments, and a polymer crystallization retardant (c); and forming an adhesive layer including a resorcinol-formalin-latex (RFL)-based adhesive on at least one surface of the base film layer.

Hereinafter, the film for an inner liner, and the method for manufacturing the film for an inner liner according to specific embodiments of the invention, will be described in more detail.

According to an exemplary embodiment of the invention, a film for an inner liner is provided, including: a base film layer including a polyamide-based resin (a), a copolymer (b) including polyamide-based segments and polyether-based segments, and a polymer crystallization retardant (c); and an adhesive layer including a resorcinol-formalin-latex (RFL)-based adhesive formed on at least one surface of the base film layer, wherein a content of the polyether-based segment of the copolymer is 2 wt % to 40 wt % based on total weight of the base film layer.

As research results of the present inventors, it was confirmed that at the time of using the base film layer formed by using the copolymer including a specific content of polyether-based segments, together with the polyamide-based resin, and the polymer crystallization retardant, the film for an inner liner capable of implementing an excellent gas barrier property even with a thin thickness to lighten a tire weight, improve mileage of automobiles, have a high heat resistant property, and exhibit mechanical physical properties such as high durability, high fatigue resistance, and the like, together with excellent formability, may be provided.

In particular, since the base film layer includes the polymer crystallization retardant, the film for an inner liner may have a low modulus property together with sufficient strength, and even after performing a forming process at a high temperature of 100° C. or more or a stretching process, a degree of crystallization of the base film layer may not be significantly increased, such that a modulus property, elasticity, elastic recovery, and the like may not be largely deteriorated to secure excellent formability.

In addition, it was confirmed that when the adhesive layer including a resorcinol-formalin-latex (RFL)-based adhesive is formed on the base film layer, strong binding to a tire may be obtained even without applying an additional vulcanization process or without largely increasing a thickness of the adhesive layer.

The polymer crystallization retardant may be used to reduce crystallinity of the polymer included in the base film layer. The polymer crystallization retardant may be a compound including at least one reactive functional group selected from the group consisting of a hydroxyl group and a carboxyl group.

Due to the polymer crystallization retardant, a cross-linkage reaction may be largely generated in polymers used or synthesized in a process for manufacturing the base film layer, for example, the polyamide-based resin (a), and the copolymer (b) including polyamide-based segments and polyether-based segments, respectively, or between the polymers, and accordingly, crystallinity of the base film layer may be reduced.

Accordingly, the film for an inner liner may have increased durability to impact from the outside, transformation itself, and the like, and may prevent a phenomenon that the film itself is broken or torn in a process for storing the film or in a process for manufacturing a tire, and the like. In addition, orientation of the base film layer is decreased, and the modulus is also decreased by a predetermined degree, such that the film for an inner liner having high elasticity and durability may be provided. Further, due to the polymer crystallization retardant, physical and chemical properties of the base film layer may also be optimized for the film for an inner liner.

The polymer crystallization retardant may include at least one compound selected from the group consisting of aromatic polycarboxylic acid, aromatic polycarboxylic acid ester, aromatic polycarboxylic acid anhydride, and polyol. As described above, the aromatic polycarboxylic acid, the aromatic polycarboxylic acid ester, the aromatic polycarboxylic acid anhydride, and the polyol, or mixtures containing two or more kinds thereof, may reduce crystallinity of the base film layer, may have higher compatibility with other components included in the base film layer, and may implement appropriate physical properties as the film for an inner liner.

The aromatic polycarboxylic acid may include a C6-C20 aromatic ring compound having 2 or more substituted carboxyl groups, and more specifically, may be benzene tricarboxylic acid, benzene tetracarboxylic acid, or mixtures thereof. An example of the benzene tricarboxylic acid may include trimesic acid or trimellitic acid. In addition, an example of the benzene tetracarboxylic acid may include benzene-1,2,4,5-tetracarboxylic acid.

The aromatic polycarboxylic acid ester may be a compound in which hydrogen of the carboxyl group in the aromatic carboxylic acid is substituted with a C1-C5 linear or branched alkyl group.

The aromatic polycarboxylic acid anhydride refers to a compound obtained by reacting two carboxyl groups in the aromatic carboxylic acid to form an anhydride functional group.

The polyol refers to a compound including two or more hydroxyl groups, and specific examples of the polyol may include pentaerythritol, dipentaerythritol, tripentaerythritol, trimethylolethane, tri methylolpropane, trimethylolbutane, glycerol and 1,3,5-tris(2-hydroxyethyl)isocyanurate, or mixtures containing two or more kinds thereof.

The base film layer may include 0.01 wt % to 8 wt % of the polymer crystallization retardant. When a content of the polymer crystallization retardant is excessively small, a degree of cross-linkage between polymers included in the base film layer may not be sufficient, such that crystallinity may not be sufficiently reduced. When a content of the polymer crystallization retardant is excessively high, compatibility with other components included in the base film layer may be decreased to deteriorate physical properties of the film for an inner liner, or the cross-linkages in the base film may be unnecessarily and largely generated.

The base film layer may further include a heat-resistant agent. The base film layer includes the heat-resistant agent together with the polymer crystallization retardant, such that degree of crystallization of the polymer may be significantly reduced, and accordingly, even when being left or exposed under a high temperature environment for a long time, physical properties are not significantly deteriorated. That is, the heat-resistant agent may be added to the base film layer to remarkably decrease a phenomenon that the base film layer is crystallized or is cured at a high level even in a process for forming a tire, and to prevent a phenomenon that cracks or damage of the inner liner occurs even in an automobile driving process during which repeated deformations are applied and high temperature occurs.

The base film layer may further include 50 ppmw to 5000 ppmw of the heat-resistant agent. When a content of the heat-resistant agent is excessively small, an effect of improving heat resistance may not be sufficient. In addition, when a content of the heat-resistant agent is excessively large, physical properties of the base film layer may be deteriorated, and the effect of improving heat resistance according to usage content may not be substantially exhibited, such that cost of a final product may be unnecessarily increased.

Specific examples of the heat-resistant agent may include an aromatic amine-based compound, a hindered phenol-based compound, a phosphorus compound, an inorganic compound, a polyamide-based compound, a polyether-based compound, or mixtures containing two or more kinds thereof. The heat-resistant agent may be applied as a powder type, a liquid type, or the like, in a preparation method to be described below.

Specific examples of the hindered phenol-based compound may include N,N′-hexamethylene bis(3,5-di-tert-4-hydroxy-hydrocinnamide) or pentaerythritol tetrakis(3-(3,5-di-tert-butyl-4-hydroxyphenyl)propionate) which is commercially available as Irganox 1010, and the like. However, examples of the hindered phenol-based compound usable as the heat resistant agent are not limited thereto.

Specific examples of the aromatic amine-based compound may include 2,2,4-trimethyl-1,2-dihydroquinoline or a polymer thereof, phenyl β-naphthylamine, phenyl-α-naphthylamine, aldol-α-naphthylamine, N,N′-bis(1-methyl-heptyl)-p-phenylenediamine, N,N′-bis(1-ethyl-3-methylphenyl)-p-phenylenediamine, p-iso-propoxyl diphenylamine, 6-ethoxy-2,2,4-trimethyl-1,2-dihydroquinoline, N-phenyl-N′-isopropyl-para-phenylenediamine, di-beta-naphthyl-paraphenylene diamine, 4,4′-bis(α,α-dimethylbenzyl-diphenylamine), N′N′-nucleic acid-1,6-diyl-bis(3-(3,5-di-tert-butyl)-4-hydroxyphenyl propionamide), or mixtures containing two or more thereof. However, examples of the aromatic amine-based compound usable as the heat resistant agent are not limited thereto.

Specific examples of the phosphorus compound may include triphenyl phosphate (PPP), triaryl phosphate, aromatic phosphoric acid ester, 2-ethylhexyl diphenyl phosphate, triethylene phosphate, tricresyl phosphate (TOP), cresylphenyl phosphate, chlor-ethyl phosphate, tris-3-chlor-propyl phosphate, tris-dichloro propyl phosphate, halogen-containing condensed phosphoric acid ester, aromatic condensed phosphoric acid ester, polyphosphate, red phosphorus, and mixtures containing two or more thereof. However, examples of the phosphorus compound usable as the heat resistant agent are not limited thereto.

Specific examples of the inorganic compound may include Mg(OH)₂, Al(OH)₂, Sb₂O₃, guanidine salt, Sb₂O₅, zinc borate, a molybdenum compound, zinc tartrate, an iodide compound such as CuI, KI, and the like, or mixtures containing two or more thereof.

Even in the case of using a mixture of CuI and KI as a heat-resistant agent, heat resistance of the base film layer may be largely improved, and even when being left or exposed under a high temperature environment for a long time, change in physical properties of the base film layer itself is not large.

In the case in which the mixture of CuI and KI is used as the heat-resistant agent, 50 ppmw to 1000 ppmw of the mixture may be used based on the base film layer. In addition, a content of copper (Cu) in the mixture of CuI and KI may be 5 wt % to 10 wt %.

Even in the case of using the mixture of CuI and KI, the content of the heat-resistant agent to be used may be largely decreased (for example, 50 ppmw to 1000 ppmw based on the base film layer), long-term heat resistance may be largely improved without substantially having an influence on other physical properties of the base film layer.

A ratio of a peak in a kayser [I-c. about 1202 cm⁻¹]) of a part having crystalline to a peak in a kayser [I-a. about 1170 cm⁻¹]) of a part having amorphism in FT-IR of the film for an inner liner may be 1.03 or less, or 1.025 to 0.82. That is, the film for an inner liner may have relatively reduced crystalline, and may have a much lower modulus property, high elasticity or elastic recovery to prevent a phenomenon that the film for an inner liner is broken or torn even in an automobile driving process during which continuous deformations and external pressure are applied, thereby securing much higher durability.

The base film layer may have an excellent gas barrier property and a relatively low modulus by using a copolymer including a specific content of polyether-based segments that afford elastomeric properties to a polyamide-based resin. Due to unique molecular chain characteristic, the polyamide-based resin included in the base film layer exhibits an excellent gas barrier property, for example, a gas barrier property about 10 to 20 times higher than that of butyl rubber generally used for a tire at the same thickness, and exhibits a modulus property which is not excessively high as compared to other resins. Further, the polyether-based segments included in the copolymer exist while being bonded or dispersed between polyamide-based segments or polyamide-based resins to thereby further reduce the modulus of the base film layer, inhibit an increase in stiffness of the base film layer, and prevent crystallization at a high temperature.

The polyamide-based resin exhibits a generally excellent gas barrier property, such that the base film layer may have low air permeability even with a thin thickness. In addition, the polyamide-based resin exhibits a modulus which is relatively lower than that of other resins, such that even though the polyamide-based resin is applied with the copolymer including the polyether-based segments in a specific content, the film for an inner liner may exhibit a relatively low modulus property, and accordingly, formability of the tire may be improved. Further, the polyamide-based resin has sufficient heat resistance and chemical stability to prevent deformation or degeneration of the film for an inner liner at the time of being exposed under high temperature condition of the process for manufacturing the tire or chemical materials such as an additive, and the like.

The polyamide-based resin may have relative viscosity of 3.0 to 3.5, preferably, 3.2 to 3.4 (96% sulfuric acid solution). When a viscosity of the polyamide-based resin is less than 3.0, sufficient elongation may not be secured due to deterioration of toughness, such that damage may occur in a tire manufacturing process or in an automobile driving process, and it may be difficult to secure physical properties of the base film layer such as a gas barrier property, formability, and the like, that are required of the film for an inner liner. In addition, when the viscosity of the polyamide-based resin is more than 3.5, the modulus or viscosity of the base film layer to be manufactured may be unnecessarily increased, and it may be difficult for the inner liner to have appropriate formability or elasticity.

A relative viscosity of the polyamide-based resin refers to a relative viscosity measured using a 96% sulfuric acid solution at room temperature. Specifically, a specimen of a predetermined polyamide-based resin (for example, a 0.025 g specimen) is dissolved in a 96% sulfuric acid solution at various concentrations to prepare two or more solutions for measurement (for example, 3 solutions for measurement are prepared by dissolving the polyamide-based resin specimen in 96% sulfuric acid so as to have concentrations of 0.25 g/dL, 0.10 g/dL, and 0.05 g/dL, respectively), and then relative viscosity of the solutions for measurement (for example, a ratio of an average passing time of the solutions for measurement to a passing time of the 96% sulfuric acid solution through a viscosity tube) may be obtained by using a viscosity tube at 25° C.

Specific examples of the polyamide-based resin which is usable in the base film layer may include polyamide-based resins, for example, nylon 6, nylon 66, nylon 46, nylon 11, nylon 12, nylon 610, nylon 612, nylon 6/66 copolymer, a nylon 6/66/610 copolymer, nylon MXD6, nylon 6T, a nylon 6/6T copolymer, a nylon 66/PP copolymer, and a nylon 66/PPS copolymer; or an N-alkoxy alkylate thereof, for example, methoxy methylate of 6-nylon, methoxy methylate of 6-610-nylon, or methoxy methylate of 612-nylon. Nylon 6, nylon 66, nylon 46, nylon 11, nylon 12, nylon 610, or nylon 612 may be preferable.

In addition, the polyamide-based resin may be included in the base film layer manufactured by using a monomer of the polyamide-based resin or a precursor of the polyamide-based resin as well as by using the polyamide-based resin itself.

The polyamide-based resin may be included in the base film layer with a residual content except for the copolymer (b) and the polymer crystallization retardant (c).

Meanwhile, as described above, the copolymer including polyamide-based segments and polyether-based segments may exist while being bonded or dispersed between polyamide-based resins to thereby further reduce the modulus of the base film layer, inhibit an increase in stiffness of the base film layer, and prevent crystallization at a high temperature.

The copolymer is included in the base film layer, such that the film for an inner liner may secure excellent mechanical physical properties such as durability, heat resistance, fatigue resistance, and the like, and implement high elasticity or elastic recovery. Accordingly, the film for an inner liner may exhibit excellent formability. A tire to which the film for an inner liner is applied may not be physically damaged or may not have deteriorated physical properties or performance even in an automobile driving process during which repeated deformations and high heat continuously occur.

When a content of the polyether-based segment of the copolymer is 2 wt % to 40 wt %, preferably 3 wt % to 35 wt %, and more preferably 4 wt % to 30 wt %, based on total weight of the base film layer, the film for an inner liner may exhibit excellent physical properties and performance.

When a content of the polyether-based segment is less than 2 wt % based on the total weight of the base film layer, the modulus of the base film layer or the film for an inner liner may be increased to deteriorate formability of a tire or to largely deteriorate physical properties according to repeated deformations. When the content of the polyether-based segment is more than 40 wt % based on the total weight of the base film layer, the gas barrier property required for the inner liner may not be good to deteriorate tire performance, and to deteriorate reactivity to an adhesive, such that it may be difficult for the inner liner to be easily adhered to a carcass layer, and it may not be easy to manufacture a uniform film since elasticity of the base film layer is increased.

The polyether-based segment may exist while being bonded with the polyamide-based segment or being dispersed between polyamide-based resins to thereby inhibit growth of large crystals in the base film layer in the tire manufacturing process or in the automobile driving process, or prevent the base film layer from being easily broken.

In addition, the polyether-based segment may further decrease the modulus of the film for an inner liner, and accordingly, even though power that is not excessively large is applied during a process of molding a tire, the film may be stretched or deformed according to a tire shape, such that formation of a tire may be easily performed. In addition, the polyether-based segment may inhibit an increase in stiffness of the film at a low temperature, prevent crystallization at a high temperature, prevent damage or tears of the film for an inner liner due to repeated deformations, and the like, and improve restoring force to the deformations of the inner liner to inhibit occurrence of wrinkles of the film due to permanent deformation, thereby improving durability of the tire or the inner liner.

The polyamide-based segment may allow the copolymer to have a predetermined level or more of mechanical physical properties and may allow the modulus property to not be largely increased. In addition, the polyamide-based segment is applied, such that the base film layer may have a thin thickness and low air permeability, and may secure sufficient heat resistance and chemical stability.

The polyamide-based segment of the copolymer may include repeat units of the following Chemical Formula 1 or Chemical Formula 2.

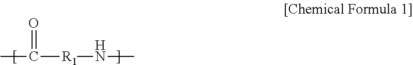

In Chemical Formula 1, R₁ is a C1-C20 linear or branched alkylene group, a C6-C20 arylene group, or a C7-C20 linear or branched arylalkylene group.

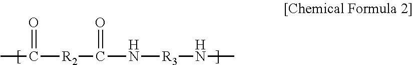

In Chemical Formula 2, R₂ is a C1-C20 linear or branched alkylene group, and R₃ is a C1-C20 linear or branched alkylene group, a C6-C20 arylene group, or a C7-C20 linear or branched arylalkylene group.

In addition, the polyether-based segment of the copolymer may include repeat units of the following Chemical Formula 3.

—R₆R₅—OₙR₇— [Chemical Formula 3]

In Chemical Formula 3, R₅ is a C1-C10 linear or branched alkylene group, n is an integer of 1 to 100, R₆ and R₇ may be the same as or different from each other, and are a direct bond, —O—, —NH—, —COO—, or —CONH—, respectively.

The copolymer including the polyamide-based segments and the polyether-based segments may have a weight average molecular weight of 50,000 to 500,000, preferably, 80,000 to 300,000. When the weight average molecular weight of the copolymer is excessively small, the base film layer to be manufactured may not secure physical properties sufficient to be used for the film for an inner liner, and may be difficult for the film for an inner liner to secure a sufficient gas barrier property. In addition, in a case in which absolute weight average molecular weight of the copolymer is excessively large, when being heated at a high temperature, the modulus or degree of crystallization of the base film layer may be excessively increased, such that it may be difficult to secure elasticity or elastic recovery that is required of the film for an inner liner.

The copolymer may include the polyamide-based segments and the polyether-based segments at a weight ratio of 6:4 to 3:7, preferably 5:5 to 4:6, within a range at which the polyether-based segment has a content of 2 wt % to 40 wt % based on total weight of the film.

As described above, when a content of the polyether-based segment is excessively small, the modulus of the base film layer or the film for an inner liner may be increased to deteriorate formability of the tire or to largely deteriorate physical properties according to repeated deformations. In addition, when the content of the polyether-based segment is excessively large, the gas barrier property of the film for an inner liner may be deteriorated, reactivity to an adhesive may be deteriorated such that it may be difficult for the inner liner to be easily adhered to the carcass layer, and it may not be easy to manufacture a uniform film since elasticity of the base film layer is increased.

In addition, in the base film layer, the polyamide-based resin and the above-described copolymer may be included at a weight ratio of 6:4 to 3:7, preferably 5:5 to 4:6. When a content of the polyamide-based resin is excessively small, density or a gas barrier property of the base film layer may be deteriorated. In addition, when the content of the polyamide-based resin is excessively large, the modulus of the base film layer may be excessively increased or formability of the tire may be deteriorated, and the polyamide-based resin may be crystallized under a high temperature environment in the tire manufacturing process or in the automobile driving process, and cracks may occur due to repeated deformations.

Meanwhile, the base film layer may be an unstretched film. When the base film layer is the unstretched film, the base film layer may have a low modulus and a high deformation ratio to be appropriately applied to a tire forming process which generates high expansion. In addition, since crystallization is hardly generated in the unstretched film, damage such as cracks and the like, even with repeated deformations, may be prevented. Further, since the unstretched film does not have an excessively large deviation in orientation in a specific direction and physical properties, the inner liner having uniform physical properties may be obtained. As described below in the manufacturing method of a film for an inner liner, the base film layer may be manufactured in a form of an unoriented film or an unstretched film by maximally inhibiting the orientation of the base film layer, for example, by viscosity control through optimization of a melt-extrusion temperature, modification of a die standard, control of a winding speed, and the like.

When the unstretched film is applied for the base film layer, the film for an inner liner may be easily manufactured in a cylindrical shape or a sheet shape in the tire manufacturing process. Particularly, in the case in which an unstretched sheet-type film is applied for the base film layer, film manufacturing facilities need not be separately constructed according to tire size, and impact, wrinkles, and the like that are applied to the film may be preferably minimized during transfer and storage. Further, in the case in which the base film layer is manufactured as a sheet type, a process of adding an adhesive layer to be described below may be more easily performed, and damage or dents which may occur during a manufacturing process due to standard difference from a forming drum may be prevented.

Meanwhile, the adhesive layer including the resorcinol-formalin-latex (RFL)-based adhesive has excellent adhesion and adhesion-maintaining performance to the base film layer and a tire carcass layer, thereby preventing a break at an interface between the film for an inner liner and the carcass layer which occurs by heat or repeated deformations in the tire manufacturing process or the driving process, such that the film for an inner liner may have sufficient fatigue resistance.

It is considered that the above-described main properties of the adhesive layer are obtained by including a specific resorcinol-formalin-latex (RFL)-based adhesive with a specific composition. Previously, as an adhesive for an inner liner, a rubber type of tie gum or the like was used, and accordingly, an additional vulcanization process was required. To the contrary, the adhesive layer includes the resorcinol-formalin-latex (RFL)-based adhesive with a specific composition to have high reactivity and adhesion to the base film layer, and the adhesive layer may be compressed under high temperature heating conditions to firmly adhere the base film layer to the carcass layer without significantly increasing the thickness. Thus, the weight of tire may become lower, the mileage of automobiles may be improved, and separation between the carcass layer and an inner liner layer or between the base film layer and the adhesive layer may be prevented even if deformations occur repeatedly in the tire manufacturing process or in the automobile driving process.

Further, since the adhesive layer may exhibit high fatigue resistance to physical/chemical deformations that may be applied in the tire manufacturing process or the automobile driving process, deterioration of adhesion or other properties may be minimized even in a manufacturing process under a high temperature condition or in the automobile driving process during which mechanical deformation is applied for a long time.

Moreover, the resorcinol-formalin-latex (RFL)-based adhesive may enable cross-linkage between a latex and rubber to exhibit adhesion performance. In addition, the resorcinol-formalin-latex (RFL)-based adhesive is physically a latex polymer to have low hardness, thereby providing a flexible property as the rubber, and forming chemical bonds between methylol end groups of a resorcinol-formalin polymer and the base film layer. Accordingly, when the resorcinol-formalin-latex (RFL)-based adhesive is applied to the base film layer, sufficient adhesive performance may be implemented.

The resorcinol-formalin-latex (RFL)-based adhesive may include 2 wt % to 32 wt %, preferably 10 wt % to 20 wt % of a condensate of resorcinol and formaldehyde, and 68 wt % to 98 wt %, preferably 80 wt % to 90 wt % of a latex.

The condensate of resorcinol and formaldehyde may be obtained by mixing resorcinol and formaldehyde at a molar ratio of 1:0.3 to 1:3.0, preferably 1:0.5 to 1:2.5, and performing a condensation reaction. In addition, the condensate of resorcinol and formaldehyde may be included in a content of 2 wt % or more based on total weight of the adhesive layer in terms of a chemical reaction for excellent adhesion, and it may be included in a content of 32 wt % or less to secure adequate fatigue resistance.

The latex may be a mixture containing one or two or more kinds selected from the group consisting of natural rubber latex, styrene/butadiene rubber latex, acrylonitrile/butadiene rubber latex, chloroprene rubber latex, styrene/butadiene/vinylpyridine rubber latex. The latex may be included in a content of 68 wt % or more based on total weight of the adhesive layer for flexibility and an effective cross-linking reaction with rubber, and it may be included in a content of 98 wt % or less for a chemical reaction with a base film and stiffness of the adhesive layer.

The adhesive layer may have a thickness of 0.1 μm to 20 μm, preferably 0.1 μm to 10 μm, more preferably 0.2 μm to 7 μm, and still more preferably 0.3 μm to 5 μm and may be formed on one surface or both surfaces of the film for an inner liner.

In the case in which the thickness of the adhesive layer is excessively thin, when a tire is inflated, the adhesive layer itself may become thinner, cross-linking adhesion between the carcass layer and the base film layer may be decreased, and stress may be concentrated on a part of the adhesive layer to decrease a fatigue property. In addition, when the thickness of the adhesive layer is excessively thick, interface separation in the adhesive layer may occur to decrease the fatigue property. Further, in order to adhere the film for an inner liner to the carcass layer of the tire, it is usual to form an adhesive layer on one surface of the base film layer. However, in the case in which a multi-layered film for an inner liner is applied, or adhesion to rubber on both surfaces is required according to a tire forming method and construction design, for example, when a film for an inner liner covers a bead part, the adhesive layer may be preferably formed on both surfaces of the base film layer.

According to another exemplary embodiment of the invention, a method for manufacturing a film for an inner liner includes: forming a base film layer by melting and extruding a mixture at 230 to 300° C., the mixture including a polyamide-based resin (a), a copolymer (b) including polyamide-based segments and polyether-based segments, and a polymer crystallization retardant (c); and forming an adhesive layer including a resorcinol-formalin-latex (RFL)-based adhesive on at least one surface of the base film layer.

The base film layer may be formed by melting and extruding the mixture including the polyamide-based resin (a), the copolymer (b), and the polymer crystallization retardant (c), and the adhesive layer may be formed on at least one surface of the base film layer, thereby providing the film for an inner liner.

It was confirmed that the film for an inner liner to be manufactured as described above is capable of implementing an excellent gas barrier property even with a thin thickness to lighten a tire weight, improve mileage of automobiles, have high heat resistance, and exhibit mechanical physical properties such as high durability, high fatigue resistance, and the like, together with excellent formability.

In addition, the film for an inner liner may have a low modulus property together with sufficient strength, and even after performing a forming process at a high temperature of 100° C. or more or a stretching process, a degree of crystallization of the base film layer may not be significantly increased, such that a modulus property, elasticity, elastic recovery, and the like may not be largely deteriorated to secure excellent formability.

As described above, the polyamide-based resin may have relative viscosity of 3.0 to 3.5, preferably, 3.2 to 3.4 (96% sulfuric acid solution).

In addition, the content of the polyether-based segment of the copolymer may be 2 wt % to 40 wt %, preferably 3 wt % to 35 wt %, and more preferably 4 wt % to 30 wt %, based on total weight of the base film layer.

Specific descriptions of the polyamide-based resin, the copolymer including polyamide-based segments and polyether-based segments, and the polymer crystallization retardant include the above-described descriptions of the film for an inner liner according to an exemplary embodiment of the invention are as described above.

The polymer crystallization retardant (c) may be sequentially or simultaneously mixed with the polyamide-based resin (a) and the copolymer (b) and be melted and extruded. In addition, the polymer crystallization retardant (c) may be mixed with the polyamide-based resin (a) and the copolymer (b) by a blending method for simple mixing or a compounding method at 240° C. to 300° C.

Meanwhile, in the forming of the base film layer, in order to extrude a film having more uniform thickness, the copolymer and the polyamide-based resin may be controlled so as to have a uniform thickness. As such, by controlling sizes of the copolymer and the polyamide-based resin, in a step of mixing the copolymer with the polyamide-based resin, a step of leaving the mixture in a feeder that is maintained at a predetermined temperature, a step of melting and extruding the mixture, and the like, the copolymer and the polyamide-based resin may be more uniformly mixed, agglomeration of the copolymer and the polyamide-based resin respectively or with each other and the resulting increase in size may be prevented, and accordingly, the base film layer having a more uniform thickness may be formed.

When the copolymer and the polyamide-based resin have similar sizes, agglomeration of raw material chips or generation of non-uniform shapes or areas may be minimized in the subsequent step of mixing, melting, or extruding, and accordingly, the base film layer having a uniform thickness over the whole area of the film may be formed. The sizes of the copolymer and the polyamide-based resin which are usable in the manufacturing method are not specifically limited.

The method for manufacturing the film for an inner liner may further include mixing the polyamide-based resin with the copolymer at a weight ratio of 6:4 to 3:7. When a content of the polyamide-based resin is excessively small, density or a gas barrier property of the base film layer may be deteriorated. In addition, when the content of the polyamide-based resin is excessively large, the modulus of the base film layer may be excessively increased or formability of the tire may be deteriorated, and the polyamide-based resin may be crystallized under a high temperature environment in the tire manufacturing process or in the automobile driving process, and cracks may occur due to repeated deformations. In the mixing step, any apparatus or method known to be usable for mixing a polymer resin may be used without specific limitations.

As described above, the copolymer may include polyamide-based segments and polyether-based segments at a weight ratio of 6:4 to 3:7.

A mixture of the polyamide-based resin and the copolymer may be supplied to an extrusion die through a feeder that is maintained at a specific temperature, for example, a temperature of 50° C. to 100° C. As the feeder is maintained at a temperature of 50° C. to 100 t, the mixture of the polyamide-based resin and the copolymer may have appropriate physical properties such as viscosity and the like, such that the mixture may be easily transferred to the extrusion die or other parts of an extruder, faulty feeding that is generated due to agglomeration of the mixture and the like may be prevented, and a more uniform base film layer may be formed in the subsequent melting and extruding process. The feeder serves to supply injected raw material to an extrusion die or other parts in an extruder, the constitution thereof is not specifically limited, and it may be a common feeder included in an extruder for manufacturing a polymer resin.

Meanwhile, by melting and extruding the mixture that is supplied to the extrusion die through the feeder at 230° C. to 300° C., the base film layer may be formed. A temperature for melting the mixture may be 230° C. to 300° C., and preferably 240° C. to 280° C. The temperature for melting the mixture needs to be higher than a melting point of a polyamide-based compound. However, when the temperature is excessively high, carbonization or decomposition may occur to deteriorate physical properties of the film, binding between the polyether-based resins may occur, or orientation may be generated in a fiber arrangement direction, which may be unfavorable for manufacturing an unstretched film.

The extrusion die may be used without specific limitations as long as it is known to be usable for extruding a polymer resin, but a T-type die may be preferably used so that a thickness of the base film layer may become more uniform or orientation may not be generated in the base film layer.

The forming of the base film layer may include extruding the mixture of the polyamide-based resin and the copolymer including the polyamide-based segments and the polyether-based segments into a film having a thickness of 30 μm to 300 μm. The thickness of the film to be manufactured may be controlled by controlling extrusion conditions, for example, a discharge amount of the extruder or a gap of the extrusion die, or by changing a winding speed of the extrusion in a cooling process or a recovery process.

In order to control the thickness of the base film layer more uniformly in the range of 30 μm to 300 μm, the die gap of the extrusion die may be controlled to be 0.3 mm to 1.5 mm. In the step of forming the base film layer, if the die gap is too small, die shear pressure and shear stress in the melt-extrusion process may become too high, and thus a uniform shape of an extruded film may not be formed and productivity may be lowered. Further, if the die gap is too large, stretching of a melt-extruded film may excessively occur to generate orientation, and a physical property difference between a machine direction and a transverse direction of the manufactured base film layer may become large.

Furthermore, in the method for manufacturing the film for an inner liner, the thickness of the base film layer manufactured by the above-described steps may be continuously measured, and according to feedback of the measurement result, a part of the extrusion die where non-uniform thickness appears, for example, a lip gap adjustment bolt of a T-die, may be controlled to reduce deviation of the base film layer to be manufactured, thereby obtaining a film having a more uniform thickness. In addition, the film thickness measurement-feedback-extrusion die control may be configured as an automated process step by using an automated system, for example an Auto Die system, and the like.

Meanwhile, the method for manufacturing the film for an inner liner may further include solidifying the base film layer formed by the melting and extruding process in a cooling part maintained at a temperature of 5 t to 40 t, preferably 10° C. to 30° C.

By solidifying the base film layer formed by the melting and extruding process in the cooling part maintained at a temperature of 5° C. to 40 t, a film shape having a more uniform thickness may be provided. If the base film layer obtained by the melting and extruding process is folded to or attached to the cooling part maintained at an appropriate temperature, stretching may not substantially occur, and the base film layer may be provided as an unstretched film.

Specifically, the solidifying step may include uniformly attaching the base film layer formed by the melting and extruding process to a cooling roll maintained at a temperature of 5° C. to 40° C. using an air knife, an air nozzle, an electrostatic charging device (a pinning device), or a combination thereof.

In the solidifying step, by attaching the base film layer formed by the melting and extruding process to the cooling roll using an air knife, an air nozzle, an electrostatic charging device (a pinning device), or a combination thereof, blowing in the air of the base film layer or partially non-uniform cooling of the base film layer and the like after extrusion may be prevented, and thus a film having a more uniform thickness may be formed, and partial areas having a relatively thick or thin thickness compared to surrounding parts in the film may not be substantially formed.

Meanwhile, a molten material extruded under specific die gap conditions may be attached or folded to a cooling roll installed at a horizontal distance of 10 mm to 150 mm, preferably 20 mm to 120 mm, from the die outlet, to eliminate stretching and orientation. The horizontal distance from the die outlet to the cooling roll may be a distance between the die outlet and a point where a discharged molten material is folded to the cooling roll. If a linear distance between the die outlet and the point at which a molten film is attached to the cooling roll is excessively small, uniform flow of melt extruded resin may be disturbed and the film may be non-uniformly cooled, and if the distance is excessively large, an effect of inhibiting film stretching may not be achieved.

In the step of forming the base film layer, except for the above-described specific steps and conditions, film extrusion processing conditions commonly used for manufacturing a polymer film, for example, a screw diameter, a screw rotation speed, a line speed, and the like may be appropriately selected.

The forming of the base film layer may further include adding a heat-resistant agent to the mixture. The heat-resistant agent may be sequentially or simultaneously mixed with the polyamide-based resin (a), the copolymer (b), and the polymer crystallization retardant (c) and be melted and extruded. In addition, the heat-resistant agent may be mixed with the polyamide-based resin (a), the copolymer (b), and the polymer crystallization retardant (c) by a blending method for simple mixing or a compounding method at 240 t to 300° C.

The heat-resistant agent in the base film layer to be manufactured may have a content of 50 ppmw to 5000 ppmw.

The heat-resistant agent may include at least one compound selected from the group consisting of an aromatic amine-based compound, a hindered phenol-based compound, a phosphorus-based compound, an inorganic compound, a polyamide-based compound, and a polyether-based compound.

The heat-resistant agent may include a mixture of copper iodide and potassium iodide. In the case in which the mixture of CuI and KI is used as the heat-resistant agent, 50 ppmw to 1000 ppmw of the mixture may be used based on the base film layer to be manufactured as above. In addition, a content of copper (Cu) in the mixture of CuI and KI may be 5 wt % to 10 wt %.

Specific description of the heat-resistant agent includes the above description of the film for an inner liner according to an exemplary embodiment of the present invention.

Meanwhile, the method for manufacturing a film for an inner liner may include forming an adhesive layer including a resorcinol-formalin-latex (RFL)-based adhesive on at least one surface of the base film layer.

The adhesive layer including the resorcinol-formalin-latex (RFL)-based adhesive may be formed by applying the resorcinol-formalin-latex (RFL)-based adhesive on one surface of the base film layer, or may be formed by laminating an adhesive film including the resorcinol-formalin-latex (RFL)-based adhesive on one surface of the base film layer.

Preferably, the forming of the adhesive layer may be performed by coating the resorcinol-formalin-latex (RFL)-based adhesive on one surface or both surfaces of the base film layer as formed above, and then performing a drying process. The formed adhesive layer may have a thickness of 0.1 μm to 20 μm, preferably 0.1 μm to 10 μm. The resorcinol-formalin-latex (RFL)-based adhesive may include 2 wt % to 32 wt % of a condensate of resorcinol and formaldehyde, and 68 wt % to 98 wt %, preferably 80 wt % to 90 wt %, of a latex.

The details of the resorcinol-formalin-latex (RFL)-based adhesive with the above specific composition are as described above.

A commonly used applying or coating method or apparatus may be used to apply the adhesive without specific limitations, but a knife coating method, a bar coating method, a gravure coating method, a spray method, or an immersion method may be used. However, a knife coating method, a gravure coating method, or a bar coating method may be preferable for uniform applying and coating of the adhesive.

After forming the adhesive layer on one surface or both surfaces of the base film layer, the drying process and an adhesive reaction may be simultaneously performed. However, in consideration of reactivity of the adhesive, a heat treatment reaction step may be separately performed after the drying process, and the step of forming the adhesive layer and the drying process and reacting process may be applied several times for thickness of the adhesive layer or application of a multi-stage adhesive. In addition, after the adhesive is applied on the base film layer, the heat treatment reaction may be performed by solidification and reaction under heat treatment condition of 100° C. to 150° C. for approximately 30 seconds to 3 minutes.

In the forming of the copolymer or the mixture, or in the melting and extruding of the copolymer, additives such as a heat resistant antioxidant, a heat stabilizer, and the like may be additionally added.

### Advantageous Effect of the Invention

According to the present invention, a film for an inner liner capable of implementing an excellent gas barrier property (low oxygen permeability) even with a thin thickness to lighten a tire weight, improve mileage of automobiles, have mechanical physical properties such as durability, fatigue resistance, and the like, together with excellent formability, and reduce crack occurrence, and a method for manufacturing the film for an inner liner, are provided.

In addition, the film for an inner liner may have a low modulus property together with sufficient strength, and even after performing a forming process at a high temperature of 100° C. or more or a stretching process, a degree of crystallization of the base film layer may not be significantly increased, such that a modulus property, elasticity, elastic recovery, and the like, may not be largely deteriorated to secure excellent formability.

### BRIEF DESCRIPTION OF THE DRAWINGS

FIG. 1 schematically shows a structure of a tire.

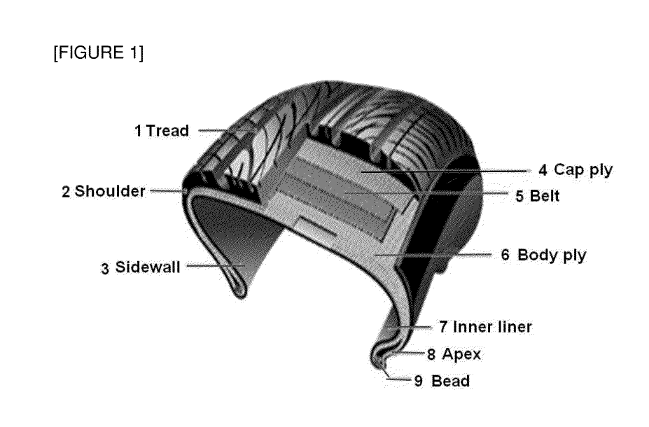

FIG. 2 shows FT-IR of a film for an inner liner according to an example of the present invention.

FIG. 3 shows FT-IR of a film for an inner liner according to Comparative Example 1.

### DETAILED DESCRIPTION OF THE EMBODIMENTS

Specific embodiments of the invention will be explained in detail in the following examples. However, these examples are only to illustrate specific embodiments of the invention, and the scope of the invention is not limited thereto.

### Example

### Manufacture of Film for Inner Liner

### Example 1

### (1) Manufacture of Base Film Layer

A mixture for manufacturing a base film was prepared by mixing a polyamide-based resin (nylon 6) having relative viscosity of 3.3 (96% sulfuric acid solution) with a copolymer resin having an absolute weight average molecular weight of 145,000 (including 60 wt % of polyamide-based repeat units and 40 wt % of polyether-based repeat units) at a weight ratio of 5:5, and adding a polymer crystallization retardant (benzene tricarboxylic acid) and a heat resistant agent (a mixture of copper iodide and potassium iodide wherein copper (Cu) has a content of 7 wt %) thereto.

In the mixture, the polymer crystallization retardant had a content of 1 wt %, and the heat resistant agent had a content of 100 ppmw.

In addition, the mixture was extruded through a T-type die (die gap—1.0 mm) at 260 t while maintaining uniform flow of the molten resin, and the molten resin was cooled and solidified in a film shape having a uniform thickness on a surface of a cooling roll which was controlled to 25° C. by using an air knife. In addition, an unstretched base film layer having a thickness of 100 μm was obtained at a speed of 15 m/min without passing stretching and heat treatment sections.

### (2) Application of Adhesive

Resorcinol and formaldehyde were mixed at a mole ratio of 1:2, and then subjected to a condensation reaction to obtain a condensate of resorcinol and formaldehyde. 12 wt % of the condensate of resorcinol and formaldehyde and 88 wt % of styrene/butadiene-1,3/vinylpyridine latex were mixed to obtain a resorcinol-formalin-latex (RFL)-based adhesive having a concentration of 20%.

In addition, the resorcinol-formalin-latex (RFL)-based adhesive was coated on the base film layer at a thickness of 1 μm by using a gravure coater, and dried and reacted at 150 t for 1 minute to form an adhesive layer.

### Comparative Examples

### Manufacture of Film for Inner Liner

### Comparative Example 1

A base film layer and a film for an inner liner were manufactured by the same method as Example 1 without using the polymer crystallization retardant.

### Comparative Example 2

40 wt % of a polyamide-based resin (nylon 6) having relative viscosity of 3.3 (96% sulfuric acid solution) with 60 wt % of a copolymer resin having an absolute weight average molecular weight of 145,000 (including 60 wt % of polyamide-based repeat units and 40 wt % of polyether-based repeat units) were mixed with each other.

In addition, the mixture was extruded through a T-type die (die gap—1.0 mm) at 260 t while maintaining uniform flow of the molten resin, and the molten resin was cooled and solidified in a film shape having a uniform thickness on a surface of a cooling roll which was controlled to 25° C. by using an air knife. In addition, an unstretched base film layer having a thickness of 100 μm was obtained at a speed of 15 m/min without passing stretching and heat treatment sections.

Application of an adhesive was performed the same as in Example 1 above.

### Experimental Example

### Measurement of Physical Properties of Film for Inner Liner

### Experimental Example 1

### Experiment of Oxygen Permeability

Oxygen permeability of each of the films for an inner liner obtained by Example 1 and Comparative Examples 1 and 2 above was measured. The specific measurement method is as follows.

(1) Oxygen Permeability: Oxygen permeability was measured according to ASTM D 3895, using an oxygen permeation analyzer (Model 8000, Illinois Instruments Company) at 25 t and in a 60 RH % atmosphere.

### Experimental Example 2

### Measurement of Internal Pressure Retention

Tires were manufactured using the films for an inner liner of Example 1 and Comparative Examples 1 and 2 above, according to the 205R/65R16 standard. Further, 90-day IPR (internal pressure retention) of the manufactured tires were measured and compared/evaluated according to Equation 2 below, under a 21° C. temperature and a 101.3 kPa pressure according to ASTM F1112-06.

$$Internal pressure retention ( \% ) = \{ 1 - \frac{\begin{matrix}Internal pressure of the \\ tire at first evaluation\end{matrix} - \begin{matrix}Internal pressure of the tire \\ after standing for 90 days\end{matrix}}{\begin{matrix}Internal pressure of \\ the tire at first evaluation\end{matrix}} \} * 100 \qquad [ Equation 2 ]$$

### Experimental Example 3

### Measurement of Modulus at Room Temperature

Tires were manufactured using the films for an inner liner of Example 1 and Comparative Examples 1 and 2, according to the 205R/65R16 standard. In the method for manufacturing the tires, green tires were manufactured, ease of manufacturing and appearance of the tires were evaluated, and then final appearance of the tires after vulcanization was determined.

Here, a case in which there was no distortion in the green tire or the tire after vulcanization, and a standard deviation of a diameter was within 5%, was evaluated as “good”. In addition, a case in which the tire was not properly manufactured due to distortion in the green tire or the tire after vulcanization, or the inner liner in the tire was melted or torn to be damaged, or a standard deviation of a diameter was more than 5%, was evaluated as “faulty appearance”.

TABLE 1
Results of Example 1 and Comparative Examples 1 and 2

| | State of | Oxygen | Internal pressure |
|---|---|---|---|
| | green tire/ | permeability | retention (%) for |
| | State of final tire | cc/(m² · 24 h · atm) | 90 days |
| Example 1 | Good/Good | 42.1 | 95.9 |
| Comparative | Good/Good | 60.6 | 95.6 |
| Example 1 | | | |
| Comparative | Good/Good | 70.2 | 96.2 |
| Example 2 | | | |

As confirmed from Table 1 above, according to Example 1 of the present invention, the base film layer having uniform physical properties over the whole area of the film was capable of being formed, and the film for an inner liner of Example 1 using the base film layer had a high gas barrier property and internal pressure retention as well as excellent formability.

### Experimental Example 4

### Experiment for Measuring Crystallinity

The films for an inner liner manufactured by Example 1 and Comparative Examples 1 and 2 were analyzed by using an ATR method of Digilab FTS-40 FT-IR. Analysis was conducted by cutting specimens used for analysis into a size of width*length of 2 mm*2 mm, and setting a pressure applied to the specimens for measurement so that the same torque as 70 cN˜m was applied to the specimens at all times by using a torque wrench.

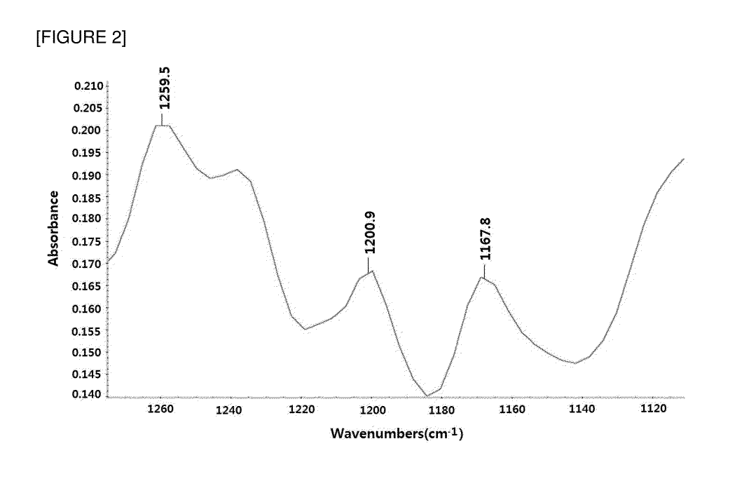

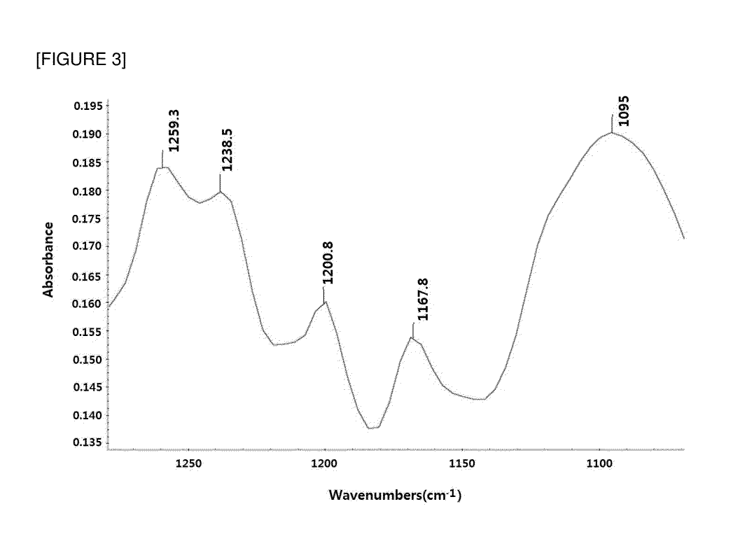

Results of FT-IR of the films for an inner liner manufactured by Example 1 and Comparative Examples 1 and 2 are shown in Table 2 below, and the measurement results of FT-IR of the films for an inner liner manufactured by Example 1 and Comparative Example 1 are shown in FIGS. 2 and 3, respectively.

TABLE 2
Results of Experimental Example 4

FT-IR

| | I-c.[1202 | I-a.[1170 | Ratio |
|---|---|---|---|
| Classification | (cm⁻¹)] | (cm⁻¹)] | I-c(1202)/I-a.(1170) |
| Comparative | 0.160 | 0.15375 | 1.0406 |
| Example 1 | | | |
| Comparative | 0.150 | 0.145 | 1.0345 |
| Example 2 | | | |
| Example 1 | 0.16833 | 0.16663 | 1.0102 |

* In Table 2 above, I-c. refers to a peak in a kayser of a part having crystallinity in FT-IR of the manufactured film for an inner liner, and I-a. refers to a peak in a kayser of a part having amorphism in FT-IR of the manufactured film for an inner liner.

As shown in Table 2 above, it was confirmed that the film for an inner liner of Example 1 had a I-c(1202)/I-a.(1170) ratio which was relatively smaller than that of the films for an inner liner of Comparative Examples 1 and 2, such that crystallinity of the film of Example 1 was also not excessively high.

Specifically, a ratio of a peak in a kayser [I-c. about 1202 cm⁻¹]) of a part having crystallinity to a peak in a kayser [I-a. about 1170 cm⁻¹]) of a part having amorphism in FT-IR of the film for an inner liner of Example 1 was 1.0102. Meanwhile, each ratio of the films for an inner liner of Comparative Examples 1 and 2 was 1.0345 or 1.0406.

In addition, upon reviewing comparison between FIGS. 2 and 3, it was confirmed that in the FT-IR spectrum of the film for an inner liner of Example 1, the peak [1202 (cm⁻¹)] of the part having crystallinity was relatively low, and in the FT-IR spectrum of the film for an inner liner of Comparative Example 1, the peak of the part having crystalline was relatively high.

That is, due to the polymer crystallization retardant, the crystallinity of the polymer included in the base film layer could be reduced, and the film for an inner liner of Example 1 could have a low modulus property together with sufficient strength, and even after performing a forming process at high temperature of 100° C. or more or a stretching process, the degree of crystallization of the base film layer could not be significantly increased, such that a modulus property, elasticity, elastic recovery, and the like, could not be largely reduced to secure excellent formability.

### Experimental Example 5

### Experiment for Measuring Durability

(1) Manufacture of Pneumatic Tire

Tires were manufactured using the films for an inner liner of Example 1 and Comparative Examples 1 and 2, according to the 205R/75R15 standard, and evaluated. Here, 1300 De′/2 ply HMLS tire cord was used for a cord included in a body ply, steel cord was used for a belt, and N66 840 De′/2 ply was used for a cap ply.

Specifically, the manufactured film for an inner liner was covered on a tire-forming drum, and in order to fix the film for an inner liner, the film was partially overlapped by a 3 cm length and the overlapped portion was fixed by a tie gum with a thickness of 1 mm. In addition, a shoulder reinforcing rubber sheet with a thickness of 2 mm was attached to one portion of the inner liner at a position at which a crimp is to be formed, with a length from 9 cm to 14 cm from the center of the drum, and with a width of 5 cm.

In addition, on the film for an inner liner, rubber for a body ply was stacked, and a bead wire, a belt part, a cap ply part, and rubber layers for forming a tread part, a shoulder part, and a side wall part were sequentially formed, to manufacture a green tire.

The manufactured green tire was put into a mold and vulcanized for 30 minutes at 160 t to manufacture a tire.

(2) Experiment for Measuring Durability

Durability of the manufactured tire was tested and evaluated by using a method for measuring tire durability according to U.S. FMVSS139. The measurement of durability was practiced by two methods of a Step Load Endurance Test which increases a load step by step and a High Speed Test which increases a speed step by step. Results thereof are shown in Table 3 below.

A tire runs about 60 million cycles under an actual use environment, and the 60 million cycles correspond to about 12 million cycles in the FMVSS139 Test. That is, it may be determined that a tire capable of performing about 12 million or more cycles in the FMVSS139 Test has appropriate durability for the actual use environment.

TABLE 3
Results of Experimental Example 5

| | | Comparative | Comparative |
|---|---|---|---|
| | Example 1 | Example 1 | Example 2 |
| Step Load | About 15 million | About 12 million | About 12 million |
| Endurance Test | | | |
| High Speed | About 15 million | About 14 million | About 13 million |
| Endurance Test | | | |

As shown in Table 3 above, it was confirmed that the tire to which the film for an inner liner of Example 1 was applied had excellent durability as compared to the tires to which the films for an inner liner of Comparative Examples 1 and 2 were applied.

From the results above, it is considered that the film for an inner liner of Example 1 could have relatively low crystallinity, and could have a much lower modulus property and high elasticity or elastic recovery to prevent a phenomenon that the film for an inner liner is broken or torn even in the automobile driving process during which continuous deformations and external pressure are applied, thereby securing much higher durability.

What is claimed is:

1. A film for an inner liner, comprising: a base film layer including a polyamide-based resin (a), a copolymer (b) including polyamide-based segments and polyether-based segments, and a polymer crystallization retardant (c); and an adhesive layer formed on at least one surface of the base film layer and including a resorcinol-formalin-latex (RFL)-based adhesive,
wherein a content of the polyether-based segment of the copolymer is 2 wt % to 40 wt % based on total weight of the base film layer.

2. The film for an inner liner of claim 1, wherein the polymer crystallization retardant (c) is a compound including at least one reactive functional group selected from the group consisting of a hydroxyl group and a carboxyl group.

3. The film for an inner liner of claim 1, wherein the polymer crystallization retardant (c) includes at least one compound selected from the group consisting of aromatic polycarboxylic acid, aromatic polycarboxylic acid ester, aromatic polycarboxylic acid anhydride, and polyol.

4. The film for an inner liner of claim 3, wherein the aromatic polycarboxylic acid includes a C6-C20 aromatic ring compound having 2 or more substituted carboxyl groups.

5. The film for an inner liner of claim 3, wherein the aromatic polycarboxylic acid includes at least one compound selected from the group consisting of benzene tricarboxylic acid and benzene tetracarboxylic acid.

6. The film for an inner liner of claim 3, wherein the polyol includes at least one compound selected from the group consisting of pentaerythritol, dipentaerythritol, tripentaerythritol, trimethylolethane, trimethylolpropane, trimethylolbutane, glycerol, and 1,3,5-tris(2-hydroxyethyl) isocyanurate.

7. The film for an inner liner of claim 1,
wherein the base film layer includes 0.01 wt % to 8 wt % of the polymer crystallization retardant.

8. The film for an inner liner of claim 1,
wherein a ratio of a peak in a kayser of a part having crystallinity to a peak in a kayser of a part having amorphism in FT-IR of the film for an inner liner is 1.03 or less.

9. The film for an inner liner of claim 1,
wherein the base film layer further includes 50 ppmw to 5000 ppmw of a heat-resistant agent.

10. The film for an inner liner of claim 9,
wherein the heat-resistant agent includes at least one compound selected from the group consisting of an aromatic amine-based compound, a hindered phenol-based compound, a phosphorus compound, an inorganic compound, a polyamide-based compound, and a polyether-based compound.

11. The film for an inner liner of claim 9,
wherein the heat-resistant agent includes a mixture of copper iodide and potassium iodide.

12. The film for an inner liner of claim 1,
wherein the polyamide-based resin (a) has a relative viscosity of 3.0 to 3.5 (96% sulfuric acid solution).

13. The film for an inner liner of claim 1,
wherein the polyamide-based segment of the copolymer includes repeat units of the following Chemical Formula 1 below or Chemical Formula 2: 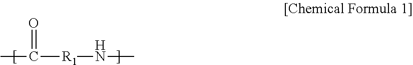
in Chemical Formula 1, R₁ is a C1-C20 linear or branched alkylene group, or a C7-C20 linear or branched arylalkylene group, and 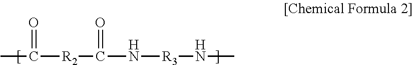
wherein, in Chemical Formula 2, R₂ is a C1-C20 linear or branched alkylene group, and R₃ is a C1-C20 linear or branched alkylene group or a C7-C20 linear or branched arylalkylene group.

14. The film for an inner liner of claim 1,
wherein the polyether-based segment of the copolymer includes repeat units of the following Chemical Formula 3:
—R₆R₅—OₙR₇— [Chemical Formula 3]
wherein, in Chemical Formula 3,
R₅ is a C1-C10 linear or branched alkylene group and n is an integer of 1 to 100, and
R₆ and R₇ are the same as or different from each other, and are a direct bond, —O—, —NH—, —COO—, or —CONH—, respectively.

15. The film for an inner liner of claim 1,
wherein the copolymer includes the polyamide-based segments and the polyether-based segments at a weight ratio of 6:4 to 3:7.

16. The film for an inner liner of claim 1,
wherein the copolymer including the polyamide-based segments and the polyether-based segments has a weight average molecular weight of 50,000 to 500,000.

17. The film for an inner liner of claim 1,
wherein the polyamide-based resin and the copolymer are included at a weight ratio of 6:4 to 3:7, in the base film layer.

18. The film for an inner liner of claim 1,
wherein the base film layer has a thickness of 30 to 300 μm, and
the adhesive layer has a thickness of 0.1 to 20 μm.

19. The film for an inner liner of claim 1,
wherein the resorcinol-formalin-latex (RFL)-based adhesive includes 2 wt % to 30 wt % of a condensate of resorcinol and formaldehyde, and 68 wt % to 98 wt % of a latex.

20. A method for manufacturing a film for an inner liner, comprising: forming a base film layer by melting and extruding a mixture at 230° C. to 300° C., the mixture including a polyamide-based resin (a), a copolymer (b) including polyamide-based segments and polyether-based segments, and a polymer crystallization retardant (c); and
forming an adhesive layer including a resorcinol-formalin-latex (RFL)-based adhesive on at least one surface of the base film layer.

21. The method of claim 20,
wherein a content of the polyether-based segment of the copolymer (b) is 2 wt % to 40 wt % based on total weight of the base film layer.

22. The method of claim 20,
further comprising mixing the polyamide-based resin with the copolymer at a weight ratio of 6:4 to 3:7.

23. The method of claim 20,
wherein the copolymer includes the polyamide-based segments and the polyether-based segments at a weight ratio of 6:4 to 3:7.

24. The method of claim 20,
wherein the forming of the base film layer includes extruding the mixture into a film having a thickness of 30 to 300 μm.

25. The method of claim 20,
further comprising solidifying the base film layer formed by the melting and extruding process in a cooling part maintained at a temperature of 5° C. to 40° C.

26. The method of claim 20,
wherein the forming of the adhesive layer includes applying an adhesive including 2 wt % to 30 wt % of a condensate of resorcinol and formaldehyde, and 68 wt % to 98 wt % of a latex at a thickness of 0.1 μm to 20 μm, on at least one surface of the base film layer.

27. The method of claim 20,
wherein the forming of the base film layer further includes adding a heat-resistant agent to the mixture.
